(19) United States
(12) Patent Application Publication
(10) Pub. No.: US 2007/0163939 A1
(43) Pub. Date: Jul. 19, 2007

(54) Distributor for water conditioner

(76) Inventor: George Raymond Field, Edmonton (CA)

Correspondence Address: GEORGE A. SEABY;SEABY & ASSOCIATES, 250 CITY CENTRE AVNUE, OTTAWA, ON, K1R6K7, CA

(21) Appl. No.: 11/331,260

(22) Filed: Jan. 13, 2006

(51) Int. Cl. B01D 21/24; B01D 24/40

(52) U.S. Cl. 210/292

(57) ABSTRACT

A conventional water conditioner includes a tank having a side wall, closed bottom and top ends, an opening in the top end, receiving and discharging material, a control valve assembly over said opening for introducing material into the tank and discharging material therefrom, a bed of particulate material for conditioning water and a dip tube extending downwardly from the assembly into the bed of particulate material. An umbrella-shaped distributor with a plurality of openings therein ensures that material entering the top of the tank around the dip tube is evenly distributed over the top surface of the bed. A bottom distributor defined by radially extending tubes ensures even distribution of liquid during the backwash cycle.

### FIELD OF THE INVENTION

This invention relates to a distributor for use in a water conditioner. In particular, the invention relates to a distributor for use in a water softener, or a filter for iron, manganese, carbon and/or sulfur, or any other precipitate.

### DISCUSSION OF THE PRIOR ART

As described in the inventor's U.S. Pat. No. 6,059,967, water conditioners or iron and/or sulfur filters include a tank containing a bed of particulate material for softening water by removing calcium and magnesium salts, or removing iron and/or sulfur from the water. Such apparatuses often have four cycles of operation, namely a service cycle during which water is filtered through the bed for use, a backflush cycle during which contaminants are removed from the bed, a regeneration cycle in which the particulate bed material is regenerated and a rinse cycle for stabilizing and flushing the bed.

During the service cycle, water flows in one direction through the bed and is discharged from the bed through a dip tube or the like for use. During backwashing, the flow of water is reversed, i.e. water flows in the opposite direction through the dip tube into the bed and upwardly to place the bed in suspension causing agitation to dislodge contaminants which are drained from the top of the tank. During some regeneration cycles, fresh chemicals are introduced into the tank to recharge the particulate material.

A problem with existing water conditioner apparatuses is that of complete use of the bed during each cycle of operation. Specifically, during the service and regeneration cycles, liquid flowing through the tank seldom contacts any more than 30-70% of the particulate material. Moreover, during backwashing recycled particulate bed material is often not evenly distributed in the tank, depleting or exhausting bed capacity unevenly and reducing bed efficiency. With conventional dip tube type apparatuses, it has been found that chemicals added during regeneration or salting cycle tend to hug the dip tube, contacting a relatively small proportion of the bed. The same thing happens in the service cycle.

The distributor described in the inventor's U.S. Pat. No. 6,059,967 offers a solution to the problem of bed use. However, the apparatus is intended for use only in the water conditioner described in the patent. Accordingly a need exists for a distributor, which can be used with any dip tube containing water conditioner. An object of the present invention is to address the need for more efficient bed use by providing a simple distributor for use in a water conditioner which ensures complete distribution of material entering the top of a water conditioner tank, maximizing bed use. Also, in the backwash cycle, water is distributed more evenly throughout the bed.

### GENERAL DESCRIPTION OF THE INVENTION

Accordingly the present invention relates to a distributor for use in a water conditioner, which includes a tank having closed bottom and top ends and an opening in the top end for receiving and discharging material; and a bed of particulate material in the tank; a valve and control assembly closing said opening; and a dip tube extending downwardly from said assembly, the distributor comprising:

a substantially umbrella-shaped body for extending over a major portion of an interior of the tank above the bed of particulate material;

a plurality of spaced apart holes in said body; and

a ring for mounting said body on a dip tube, whereby material entering the tank through said opening around the dip tube is evenly distributed over the top surface of the bed.

### BRIEF DESCRIPTION OF THE DRAWINGS

The invention is described below in greater detail with reference to the accompanying drawings, wherein:

FIG. 1 is a schematic, longitudinal sectional view of a conventional water conditioner;

FIG. 2 is a schematic, longitudinal sectional view of a water conditioner containing the distributors of the present invention;

FIG. 3 is a side view of a top distributor of FIG. 2 on a larger scale; and

FIG. 4 is a top view of the distributor of FIG. 3.

### DESCRIPTION OF THE PREFERRED EMBODIMENT

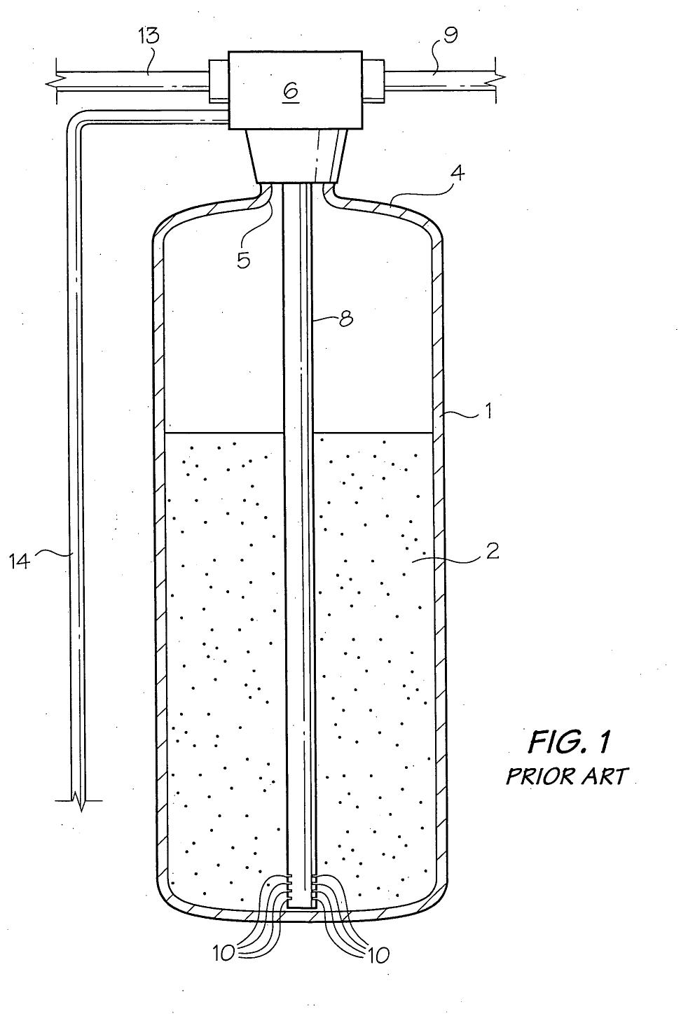

Referring to FIG. 1, a conventional water conditioner includes a tank 1 containing a bed 2 of particulate material for conditioning the water. The tank 1 has a closed bottom end 3 and a top end 4 with a central opening 5 which is closed by a valve and control assembly 6. A dip tube 8 extends downwardly from the assembly 6 into the center of the tank 1. During the service cycle of operation, water enters the tank 1 via an inlet pipe 9, the assembly 6 and the opening 5. The water percolates downwardly through the bed 2 and enters the dip tube 8 through slits 10 in the otherwise closed bottom end of the dip tube 8. The thus conditioned water flows upwardly and is discharged for use via the assembly 6 and an outlet pipe 13.

During periodic backwash cycles to clean the bed 2 of contaminants, water enters, the tank 1 through the dip tube 8 and is discharged into the bed 2 via the slits 10 in the bottom end of the tube 8. The water places the bed in suspension and causes agitation to dislodge bed contaminates, which are drained from the top of the tank via the assembly 6 and a drainpipe 14. During regeneration cycles, chemicals from a source thereof (not shown) are fed into the tank 1 via the assembly 6 and the opening 5.

As mentioned above, liquid flowing through the tank 1 seldom contacts any more than 30-70% of the particulate material forming the bed 2. The use of a bottom distributor in the form of the slits 10 at the bottom end of the dip tube 8 do not ensure that much of the bed 2 is contacted by liquid during the backwash cycle. The same is true during the service or regeneration cycles when material enters the tank 1 through the opening 5.

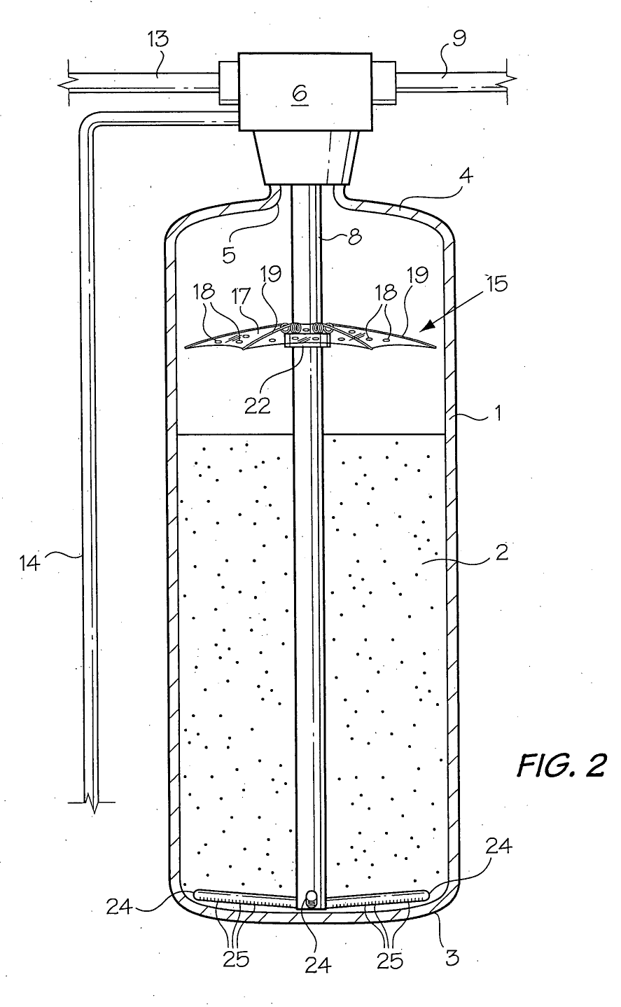

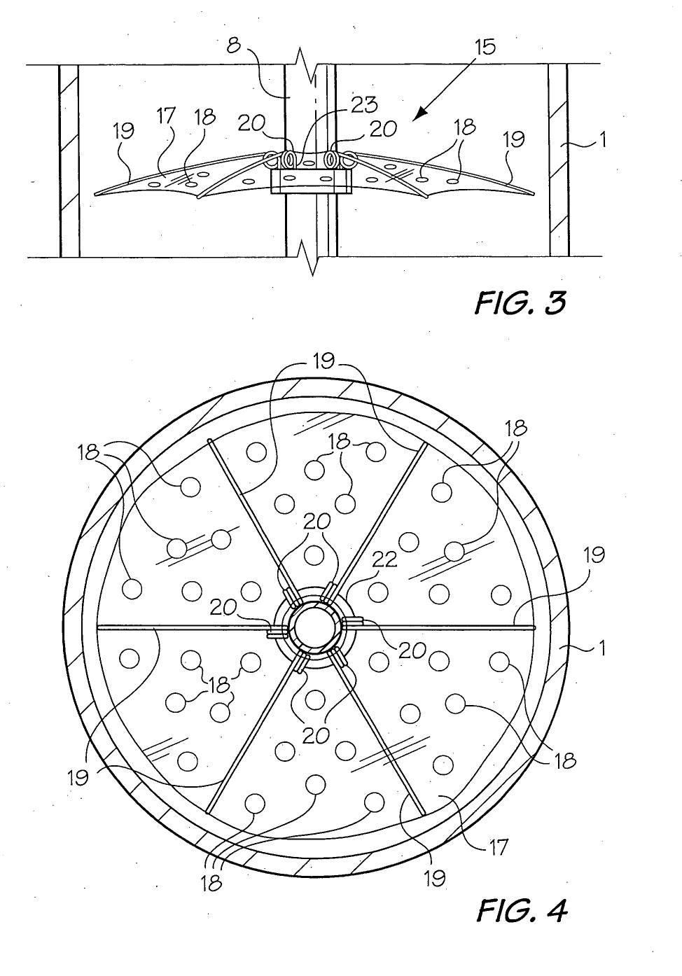

In accordance with the present invention, a top distributor indicated generally at 15 solves the problem of liquid/bed contact during the service, regeneration and backwash cycles. Referring to FIGS. 2 to 4, the top distributor 15 includes an umbrella-shaped body 17 formed of a thin plastic or other sheet material, e.g. polyethylene which includes a plurality of spaced apart holes 18. The body 17 is maintained in the open position shown in the drawings by a plurality of radially extending spokes 19. The spokes 19 are resilient. For such purpose, spring coils 20 are provided at the inner ends of the spokes 19. A ring 22, on the dip tube 8 holds the spokes 19 and consequently the distributor 15 in position.

Material entering the tank 1 through the opening 5 encounters the top of the distributor body 17 and flows downwardly towards the periphery of the tank 1. Some of the material flows around the outer periphery of the body 17 to the outside of the bed 2. The remaining material flowing down the body 17 flows through the holes 18 to the various areas of the bed 2. In order to ensure even distribution of the water or other material to the top of the bed 2, the holes 18 are arranged in concentric circles with the holes in one circle being staggered with respect to the holes in an adjacent circle. In the preferred embodiment, the circle closest to the dip tube 8 includes one hole 8 between each adjacent pair of spokes 19. Succeeding circles moving outwardly from the tube 8 contain two, then one and finally two holes 18 between each adjacent pair of spokes 19. Moreover, the holes 18 in alternating circles are radially aligned.

Referring to FIG. 2, the top distributor 15 is preferably used in combination with a bottom distributor defined by slightly inclined tubes 24 extending radially outwardly from the bottom end of the dip tube 8. Liquid enters and is discharged from the tubes via slits 25. The top distributor 15 ensures even distribution of liquid above the bed during the service and regeneration cycles, and the bottom distributor ensures even distribution of the liquid in the bed 2 during the backwash cycle.

1. (canceled)

2. The water conditioner of claim 7 including a plurality of spokes connected at one end to said ring and extending radially outwardly therefrom for supporting said body.

3. The water conditioner of claim 2, including spring coils in said one end of each said spoke connected to said ring, whereby the spokes and body are resilient.

4. The water conditioner of claim 3, wherein the body is formed of polyethylene.

5. (canceled)

6. (canceled)

7. A water conditioner comprising a tank having a side wall, a top end, a bottom end and an opening in the top end for receiving and discharging material; a bed of particulate material in the tank;
a valve and control assembly closing the opening in the top end of the tank;
a dip tube extending downwardly from said assembly into the bed of particulate material; and
a distributor in said tank above said bed of particulate material for evenly distributing material entering the tank through said opening over a top surface of said bed, the distributor including
a substantially umbrella-shaped body extending over a major portion of an interior of the tank above the bed of particulate material;
a plurality of spaced apart holes in said body permitting the flow of liquid through the body, said holes being arranged in concentric circles, a hole in one circle being staggered with respect to holes in adjacent circles and the holes in alternating circles being radially aligned with each other; and
a ring for mounting said body on the dip tube,
whereby material entering the tank through said opening around the dip tube is evenly distributed over the top surface of the bed.
